(19) United States
(12) Patent Application Publication
(10) Pub. No.: US 2025/0251985 A1
(43) Pub. Date: Aug. 7, 2025

(54) CATALYST APPLICATION FOR EXTRACTING AND EXECUTING TASKS

(71) Applicant: Dropbox, Inc., San Francisco, CA (US)

(72) Inventors: Devin Mancuso, San Francisco, CA (US); Richard Chan, San Francisco, CA (US); Theo Richardson, Toronto (CA)

(21) Appl. No.: 18/435,023

(22) Filed: Feb. 7, 2024

(51) Int. Cl. G06F 9/50

(52) U.S. Cl. CPC G06F 9/5038

(57) ABSTRACT

The present disclosure is directed toward systems, methods, and non-transitory computer readable media for utilizing a catalyst application to analyze digital content of another computer application to generate or extract tasks. The catalyst application can accompany and operate in conjunction with another computer application to extract data from the application and generate tasks. For example, the disclosed systems can scan displayed (or otherwise presented) digital content in an application and can generate a prompt for causing a large language model to identify or extract tasks from the digital content. Through the catalyst application, the disclosed systems can thus implement a large language model to generate a task list from the digital content of another computer application. The disclosed systems can further utilize the catalyst application to automatically execute or perform extracted tasks.

### BACKGROUND

Advancements in computing devices and networking technology have given rise to a variety of innovations in cloud-based digital content storage and access. For example, online digital content systems can provide access to, and synchronize changes for, digital content items across devices all over the world. Existing systems can also provide a suite of computer applications to accomplish a variety of tasks in a workday, such as arranging a digital calendar, managing tasks, initiating and attending video calls, and sending and receiving digital communications (e.g., text messages, emails, and instant messages) in various formats. Indeed, modern online digital content systems can provide access to, and communicate about, digital content for user accounts across diverse physical locations and over a variety of computing devices. Despite these advances, however, existing digital content systems continue to suffer from a number of disadvantages, particularly in terms of flexibility and efficiency.

As just suggested, some existing digital content systems are inflexible. In particular, the task management function of many existing systems is rigidly fixed to specific computer applications. To generate or modify a task event, existing systems generally require opening and navigating to a specific task management application to input or modify the task. Indeed, in most existing systems, scheduling tasks is an entirely separate process from other application data running on (or available to) a client device, and existing systems cannot automatically adapt the task extraction process to application data available in other, unrelated computer applications running on the client device.

Due at least in part to their inflexibility, many existing digital content systems are also inefficient. To elaborate, because existing systems cannot flexibly adapt task extraction functions across different software contexts, these systems often require frequent navigation between multiple different computer applications, from those running their own specific operations (e.g., web browser applications, email applications, instant messaging applications, or video call applications) to those dedicated to task management. Beyond extracting tasks, existing systems further require navigating across many applications to execute extracted tasks (e.g., where tasks are performed in their own respective applications). Not only is such frequent context switching navigationally inefficient (requiring excessive client device interactions to access desired data and/or functionality across the applications), but it is computationally inefficient as well. Indeed, simultaneously running a task management application to generate calendar events from data available in one or more other running applications utilizes additional processing power. In addition, switching back and forth between computer applications (e.g., a task management application and another application) consumes excessive amounts of memory as a client device caches larger amounts of data for each of the applications that is frequently accessed (as compared to idle or less frequented applications).

Thus, there are several disadvantages with regard to existing digital content systems.

### SUMMARY

This disclosure describes one or more embodiments of systems, methods, and non-transitory computer readable storage media that provide benefits and/or solve one or more of the foregoing and other problems in the art. For instance, the disclosed systems utilize a catalyst application to analyze digital content of another computer application (e.g., a web browser application, an email application, an instant messaging application, or a video call application) to generate or extract tasks. The catalyst application can accompany and operate in conjunction with the other computer application to extract data from the application and generate tasks extemporaneously (e.g., in real time as data is presented). For example, the disclosed systems can scan displayed (or otherwise presented) digital content in an application and can generate a prompt for causing a large language model to identify or extract tasks from the digital content. Through the catalyst application, the disclosed systems can thus implement a large language model to generate a task list from the digital content of another computer application. The disclosed systems can further utilize the catalyst application to automatically execute or perform extracted tasks.

### BRIEF DESCRIPTION OF THE DRAWINGS

This disclosure will describe one or more example implementations of the systems and methods with additional specificity and detail by referencing the accompanying figures. The following paragraphs briefly describe those figures.

FIG. 1 illustrates a schematic diagram of an example environment of a task catalyst system in accordance with one or more embodiments.

FIG. 2 illustrates an example overview of generating, providing, and executing tasks using a task catalyst application in accordance with one or more embodiments.

FIG. 3 illustrates an example interface for extracting task data in response to interaction with a catalyst bauble in accordance with one or more embodiments.

FIG. 4 illustrates an example diagram for generating a task list utilizing a large language model in accordance with one or more embodiments.

FIG. 5 illustrates an example diagram for executing a task in accordance with one or more embodiments.

FIGS. 6A-6C illustrate an example catalyst interface for visualizing and executing tasks in accordance with one or more embodiments.

FIG. 7 illustrates an example catalyst interface in the form of a feed card in accordance with one or more embodiments.

FIG. 8 illustrates an example flowchart of a series of acts for generating, providing, and executing tasks using a task catalyst application in accordance with one or more embodiments.

FIG. 9 illustrates a block diagram of an exemplary computing device in accordance with one or more embodiments.

FIG. 10 illustrates an example environment of a networking system having the task catalyst system in accordance with one or more embodiments.

### DETAILED DESCRIPTION

This disclosure describes one or more embodiments of a task catalyst system that can extract tasks from digital content displayed or otherwise presented on a client device. Indeed, the task catalyst system can provide a task catalyst application that operates together with, and follows active windows of, various computer applications running a client device to automatically (and extemporaneously) generate task lists during normal device operation. For example, the task catalyst system can scan content of a computer application (e.g., a web browser application, an email application, an instant messaging application, or a video call application) and can generate a task generation prompt for generating a task list from the scanned content. To generate the task list, the task catalyst system can provide the task generation prompt to a large language model for analyzing the scanned content, extracting tasks, and generating a curriculum of tasks (e.g., a task list) from the extracted tasks. In addition, the task catalyst system can execute extracted tasks using a task catalyst application.

As just mentioned, the task catalyst system can utilize a task catalyst application to generate a task list from digital content presented within a computer application on a client device. To scan content from a computer application, the task catalyst system can detect an entry point trigger, such as a client device interaction with a catalyst bauble (e.g., a floating, moveable user interface element that accompanies and/or follows active application windows) to initiate task extraction. In some cases, the task catalyst system detects other forms of entry point triggers, such as detecting key words spoken during a video call or identified during language processing of a call transcript. The task catalyst system can further scan currently displayed content of an application window and/or previously displayed content (e.g., previously displayed via the active application window or in a related application window). For instance, the task catalyst system can analyze currently displayed content along with content previously displayed within a threshold time duration (e.g., from a previous point in time up to what is currently shown) within the same application (but in a different window) or the same application window.

Based on detecting an entry point trigger, the task catalyst system can generate a task generation prompt for providing to a large language model. To elaborate, in response to initiating task extraction via the task catalyst application, the task catalyst system can generate a prompt that includes natural language terminology requesting a large language model to generate a task list from the depicted digital content of the computer application. In some cases, the task catalyst system generates the prompt by converting displayed digital content into text form and generating terminology requesting task list generation from the text form of the digital content.

To generate a task list from the scanned digital content, the task catalyst system can provide the task generation prompt to a large language model, along with the text form of the digital content. The task catalyst system can thus cause the large language model to generate a task list from the scanned digital content by identifying language (in the text form of the digital content) indicating calls to action. The task catalyst system can further provide the generated task list for display on a client device (e.g., on a client device of a user account indicated to perform the tasks in the task list). In some cases, the task catalyst system can also use the task catalyst application to automatically (e.g., without user interaction) execute one or more tasks within the task list.

As suggested above, through one or more of the embodiments mentioned above (and described in further detail below), the task catalyst system can provide several improvements or advantages over existing digital content systems. For example, the task catalyst system can improve flexibility compared to prior systems. While many prior systems use task management applications that are rigidly fixed in their own separate contexts apart from other computer applications, the task catalyst system utilizes a task catalyst application that more flexibly adapts to, and integrates with, the contexts of other computer applications. Specifically, the task catalyst application includes a catalyst bauble that follows active application windows running on a client device and which is selectable (as an entry point) to trigger task extraction from content depicted within an active application window.

Due at least in part to its improved flexibility, the task catalyst system can also improve efficiency over existing digital content systems. For example, as opposed to prior systems that are navigationally inefficient by requiring frequent navigation between a task management application and other computer applications, the task catalyst system provides a task catalyst application that follows active application windows for automatic (and extemporaneous) task extraction without such navigation or further prompting. In addition, the task catalyst system can utilize the task catalyst application to automatically execute various tasks without further client device interaction with applications for carrying out the tasks.

In addition to improved navigational efficiency, the task catalyst system can also provide improved computational efficiency as well. Rather than simultaneously running a task management application in a separate window apart from another computer application (as in many prior systems), the task catalyst system provides a catalyst bauble that accompanies active application windows for direct interaction with a (light version of a) task catalyst application to perform task extraction. By circumventing the need of prior systems to constantly switch between a task management application and other applications, the task catalyst application thus preserves processing power and memory. Indeed, by not requiring an entirely separate application window for the task catalyst application, the task catalyst system preserves memory compared to prior systems by caching less overall application window data for fewer applications (and fewer windows).

As illustrated by the foregoing discussion, the present disclosure utilizes a variety of terms to describe features and benefits of the task catalyst system. Additional detail is hereafter provided regarding the meaning of these terms as used in this disclosure. As used herein, the term “digital content item” (or simply “content item”) refers to a digital object or a digital file that includes information interpretable by a computing device (e.g., a client device) to present information to a user. A digital content item can include a file or a folder such as a digital text file, a digital image file, a digital audio file, a webpage, a website, a digital video file, a web file, a link, a digital document file, or some other type of file or digital object. A digital content item can have a particular file type or file format, which may differ for different types of digital content items (e.g., digital documents, digital images, digital videos, or digital audio files). In some cases, a digital content item can refer to a remotely stored (e.g., cloud-based) item or a link (e.g., a link or reference to a cloud-based item or a web-based content item) and/or a content clip that indicates (or links/references) a discrete selection or segmented sub-portion of content from a webpage or some other content item or source. A content item can also include application-specific content that is siloed to a particular computer application but is not necessarily accessible via a file system or via a network connection. A digital content item can be editable or otherwise modifiable and can also be sharable from one user account (or client device) to another. In some cases, a digital content item is modifiable by multiple user accounts (or client devices) simultaneously and/or at different times.

As mentioned, the task catalyst system can generate a task list utilizing a task catalyst application. As used herein, the term “task” refers to one or more computer processes executable by one or more computer applications and corresponding to an action identified from one or more content items. Example tasks include “identify user accounts within the team,” “generate a progress report,” and “create a content calendar for the campaign.” Accordingly, the term “task list” refers to a collection, a list, or a curriculum of multiple tasks that are part of, or whose accomplishment works toward, an overarching goal or project. Relatedly, the term “task catalyst application” refers to a computer application that executes all or part of the functionality of the task catalyst system, including extracting content items or digital content from application windows, generating task generation prompts for generating task lists, presenting task lists, and executing tasks.

As noted, the task catalyst system can generate a task list utilizing a large language model to process a task generation prompt. As used herein the term “task generation prompt” refers to a set of natural language terms arranged to prompt or cause a large language model to perform a particular task or generate a particular output. In some cases, a task generation prompt includes language defining a request along with accompanying language extracted or generated from scanned digital content of one or more application windows.

Along these lines, the term “large language model” refers to a set of one or more machine learning models trained to perform computer tasks to generate or identify computing code and/or data in response to trigger events (e.g., user interactions, such as text queries and button selections). In particular, a large language model can be a neural network (e.g., a deep neural network) with many parameters trained on large quantities of data (e.g., unlabeled text) using a particular learning technique (e.g., self-supervised learning). For example, a large language model can include parameters trained to generate or identify computing code and/or data based on various contextual data, including information from historical user account behavior.

Relatedly, as used herein, the term “machine learning model” refers to a computer algorithm or a collection of computer algorithms that automatically improve for a particular task through iterative outputs or predictions based on use of data. For example, a machine learning model can utilize one or more learning techniques to improve in accuracy and/or effectiveness. Example machine learning models include various types of neural networks, decision trees, support vector machines, linear regression models, and Bayesian networks. In some embodiments, the task catalyst system utilizes a large language machine learning model in the form of a neural network.

Along these lines, the term “neural network” refers to a machine learning model that can be trained and/or tuned based on inputs to determine classifications, scores, or approximate unknown functions. For example, a neural network includes a model of interconnected artificial neurons (e.g., organized in layers) that communicate and learn to approximate complex functions and generate outputs (e.g., task lists) based on a plurality of inputs provided to the neural network. In some cases, a neural network refers to an algorithm (or set of algorithms) that implements deep learning techniques to model high-level abstractions in data. A neural network can include various layers such as an input layer, one or more hidden layers, and an output layer that each perform tasks for processing data. For example, a neural network can include a deep neural network, a convolutional neural network, a recurrent neural network (e.g., an LSTM), a graph neural network, a transformer neural network, a diffusion neural network, a generative adversarial neural network, or a large language model.

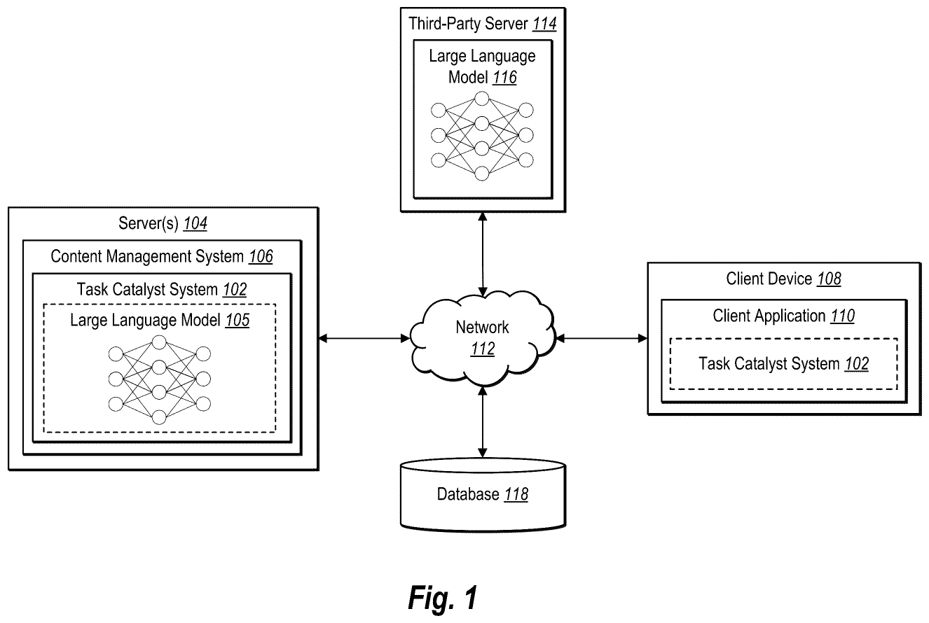

Additional detail regarding the task catalyst system will now be provided with reference to the figures. For example, FIG. 1 illustrates a schematic diagram of an example system environment for implementing a task catalyst system 102 in accordance with one or more implementations. An overview of the task catalyst system 102 is described in relation to FIG. 1. Thereafter, a more detailed description of the components and processes of the task catalyst system 102 is provided in relation to the subsequent figures.

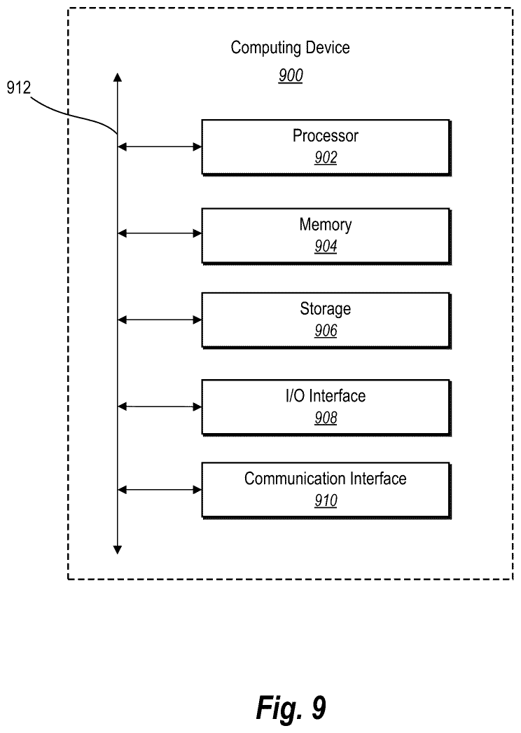

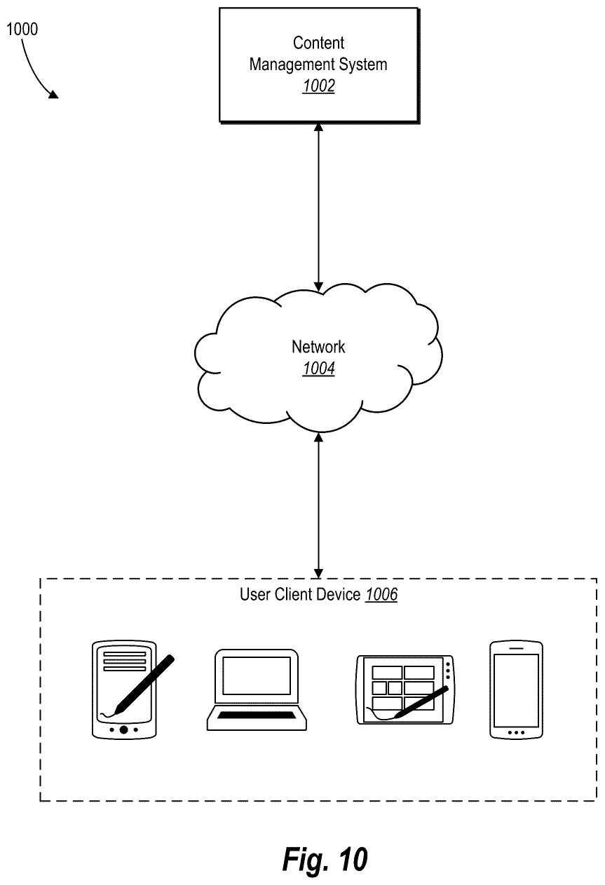

As shown, the environment includes server(s) 104, client device 108, a third-party server 114, a database 118, and a network 112. Each of the components of the environment can communicate via the network 112, and the network 112 may be any suitable network over which computing devices can communicate. Example networks are discussed in more detail below in relation to FIGS. 9-10.

As mentioned above, the example environment includes a client device 108. The client device 108 can be one of a variety of computing devices, including a smartphone, a tablet, a smart television, a desktop computer, a laptop computer, a virtual reality device, an augmented reality device, or another computing device as described in relation to FIGS. 9-10. The client device 108 can communicate with the server(s) 104 via the network 112. For example, the client device 108 can receive user input from a user interacting with the client device 108 (e.g., via the client application 110) to, for instance, access, generate, modify, or share a content item, to collaborate with a co-user of a different client device, or to select a user interface element. In addition, the task catalyst system 102 on the server(s) 104 can receive information relating to various interactions with content items and/or user interface elements based on the input received by the client device 108 (e.g., to generate a task list and/or to execute one or more tasks).

As shown, the client device 108 can include a client application 110. In particular, the client application 110 may be a web application, a native application installed on the client device 108 (e.g., a mobile application, a desktop application, etc.), or a cloud-based application where all or part of the functionality is performed by the server(s) 104. Based on instructions from the client application 110, the client device 108 can present or display information, including a catalyst interface for presenting graphical visualizations of task lists as well as interface elements for executing and monitoring progress of various tasks.

As illustrated in FIG. 1, the example environment also includes the server(s) 104. The server(s) 104 may generate, track, store, process, receive, and transmit electronic data, such as digital content (e.g., content items), tasks, task lists, prompts, interface elements, interactions with digital content items, interactions with interface elements, and/or interactions between user accounts or client devices. For example, the server(s) 104 may receive data from the client device 108 in the form of a task generation prompt and/or indications of various digital content from which to generate a task list. In addition, the server(s) 104 can transmit data to the client device 108 in the form of a catalyst interface that includes a graphical visualization of a task list generated from the task generation prompt. Indeed, the server(s) 104 can communicate with the client device 108 to send and/or receive data via the network 112. As shown, the server(s) 104 can also include a large language model 105 that is native to, housed or hosted on, and/or maintained by the content management system 106. In some implementations, the server(s) 104 comprise(s) a distributed server where the server(s) 104 include(s) a number of server devices distributed across the network 112 and located in different physical locations. The server(s) 104 can comprise one or more content servers, application servers, communication servers, web-hosting servers, machine learning server, and other types of servers.

As shown in FIG. 1, the server(s) 104 can also include the task catalyst system 102 as part of a content management system 106. The content management system 106 can communicate with the client device 108 to perform various functions associated with the client application 110 such as managing user accounts, managing content collections, managing content items, and facilitating user interaction with the content collections and/or content items. Indeed, the content management system 106 can include a network-based smart cloud storage system to manage, store, and maintain content items and related data across numerous user accounts, including user accounts in collaboration with one another. In some embodiments, the task catalyst system 102 and/or the content management system 106 utilize a database 118 to store and access information such as digital content items, tasks, task lists, prompts, and other data.

FIG. 1 further illustrates a third-party server 114. In particular, the third-party server 114 can host or house a large language model 116 (e.g., as an alternative to the server(s) 104 hosting or housing the large language model 116) for access by the task catalyst system 102. For example, the third-party server 114 can include a server location hosting the large language model 116 that is external to the task catalyst system 102. In some cases, the third-party server 114 is external to the task catalyst system 102, but the task catalyst system 102 can nevertheless access and utilize the large language model 116 via one or more plugins, APIs, or other network-based access protocols.

Although FIG. 1 depicts the task catalyst system 102 located on the server(s) 104, in some implementations, the task catalyst system 102 may be implemented by (e.g., located entirely or in part on) one or more other components of the environment. For example, the task catalyst system 102 may be implemented by the client device 108 and/or a third-party device. For example, the client device 108 can download all or part of the task catalyst system 102 for implementation independent of, or together with, the server(s) 104.

In some implementations, though not illustrated in FIG. 1, the environment may have a different arrangement of components and/or may have a different number or set of components altogether. For example, the client device 108 may communicate directly with the task catalyst system 102, bypassing the network 112. As another example, the environment can include the database 118 located external to the server(s) 104 (e.g., in communication via the network 112) or located on the server(s) 104, on a third-party system, and/or on the client device 108.

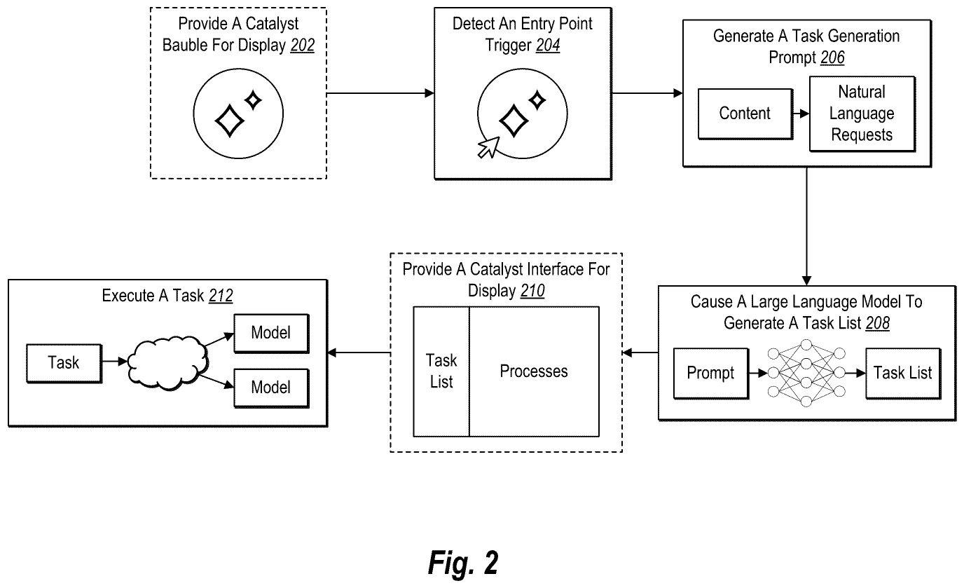

As mentioned above, the task catalyst system 102 can generate and provide a task list from application content using a task catalyst application. In particular, the task catalyst system 102 can generate a task list utilizing a large language model to synthesize or extract tasks from content depicted within one or more application windows presented on a client device. FIG. 2 illustrates an overview of generating and executing task lists from application window content in accordance with one or more embodiments. Additional detail regarding the various acts and processes introduced in relation to FIG. 2 is provided thereafter with reference to subsequent figures.

As illustrated in FIG. 2, in some embodiments, the task catalyst system 102 performs an act 202 to provide a catalyst bauble for display. In particular, the task catalyst system 102 generates and provides a catalyst bauble as a cross-window interface element that follows active application windows during operation of a client device. To elaborate, the task catalyst system 102 monitors applications windows of a client device to detect active applications window. In some cases, the task catalyst system 102 communications with an operating system of a client device to detect or determine which application windows are active because they are currently receiving user interactions and/or are consuming a particular amount of processing power and/or memory. Based on detecting or identifying an active application window, the task catalyst system 102 moves a catalyst bauble (e.g., a circular interface element) to accompany, integrate with, or attach to the active application window. The catalyst bauble acts as an entry point or a quick access for a task catalyst application, providing menu options and interactive elements for performing task catalyst application functions without leaving (or navigating away from) the active application window.

As also illustrated in FIG. 2, the task catalyst system 102 performs an act 204 to detect an entry point trigger. The task catalyst system 102 detects an entry point trigger to trigger or initiate a task catalyst application. For instance, the task catalyst system 102 detects user interaction with a catalyst bauble to request task extraction from digital content displayed in one or more application windows (e.g., an active application window) presented on a client device. In some cases, the task catalyst system 102 detects an entry point trigger by passively listening (e.g., via a task catalyst application) to a video call to detect one or more key words requesting task extraction and/or key words defining calls to action that are extractable as tasks. Similarly, the task catalyst system 102 can detect an entry point trigger by automatically (e.g., without user interaction prompting) scanning digital content of an (active) application window to identify calls to action or other data extractable as tasks.

As further illustrated in FIG. 2, the task catalyst system 102 performs an act 206 to generate a task generation prompt. More specifically, in response to an entry point trigger, the task catalyst system 102 generates a task generation prompt by scanning displayed content within one or more application windows. In some embodiments, the task catalyst system 102 can scan digital content (e.g., content items) within an active application window (and/or from inactive or other application windows) and/or from a history of content presented via the active application window. In these or other embodiments, the task catalyst system 102 can analyze digital content in the form of audio data from one or more video calls. For instance, the task catalyst system 102 can generate text representations of captured digital content (e.g., displayed in an application window and/or from audio data) and can generate terminology for requesting task extraction from the text representations (and/or from the unconverted, non-text-representations) of digital content. In some cases, the task catalyst system 102 provides scanned content (e.g., text representations of scanned content) to a large language model along with a predefined request for generation of a task generation prompt (e.g., “analyze the accompanying content to generate a list of tasks” or “summarize the accompanying content as a task list”). The task catalyst system 102 thus generates a task generation prompt in the form of a combination of a natural language request and accompanying (text representations of) digital content for providing to a large language model.

As further shown in FIG. 2, the task catalyst system 102 performs an act 208 to cause a large language model to generate a task list. To elaborate, the task catalyst system 102 generates a task list by providing a task generation prompt to a large language model, thereby causing the large language model to generate a task list from (text representations of) scanned digital content. In some embodiments, the task catalyst system 102 utilizes an external large language model hosted at a third-party server. In other embodiments, the task catalyst system 102 utilizes an internal large language model hosted and maintained by the content management system 106. In either case, the task catalyst system 102 causes the large language model to analyze or process (text representations of) scanned digital content depicted within one or more application windows (e.g., an active application windows) on a client device.

From the analysis, the task catalyst system 102 causes the large language model to generate one or more task lists. In some cases, the task catalyst system 102 (through the large language model) generates goal-specific task lists by determining tasks that correspond to (e.g., whose accomplishment works toward) a common goal (e.g., an overarching project) and listing tasks for the common goal together. The task catalyst system 102 can thus generate multiple task lists for multiple goals. In addition, the task catalyst system 102 (through the large language model) can identify extracted tasks that correspond to a previously generated task list (or its corresponding goal/project) and can add the new task to the existing list. If no previously generated task list exists for an identified goal, the task catalyst system 102 can generate a new task list for the newly identified goal.

As further illustrated in FIG. 2, in some embodiments, the task catalyst system 102 performs an act 210 to provide a catalyst interface for display. More specifically, the task catalyst system 102 provides a catalyst interface (of the task catalyst application) that includes a visual representation of a generated task list. In some cases, the catalyst interface includes tools for saving tasks for execution, executing saved tasks, and visualizing execution of tasks. In certain embodiments, the catalyst interface expands from a catalyst bauble to show task list and other content. In these or other embodiments, the catalyst interface exists outside of the catalyst bauble and is independently viewable and manipulable as the bauble follows active display windows of a client device. As explained in further detail below, the catalyst interface comes in multiple forms.

Additionally, as shown in FIG. 2, the task catalyst system 102 performs an act 212 to execute a task. In response to a user interaction with an execution element within a catalyst interface, the task catalyst system 102 executes the corresponding task. To execute a task, the task catalyst system 102 determines and communicates with one or more internal and/or external models (e.g., large language models or other models) corresponding to the task. The task catalyst system 102 can send a task execution request to an identified model to cause the model to execute the task. Task execution can involve scanning one or more databases for data specific to the executing the task and generating a model output from the task data. In some embodiments, the model output is a content item such as a digital image, a digital video, a digital document, or a text response to a query. In some cases, task execution takes place over an extended timeframe where the task catalyst system 102 performs a time-based task with periodic repetitions and/or monitors changes in data over time (e.g., to summarize a series of video calls with a particular team of user accounts over the upcoming month).

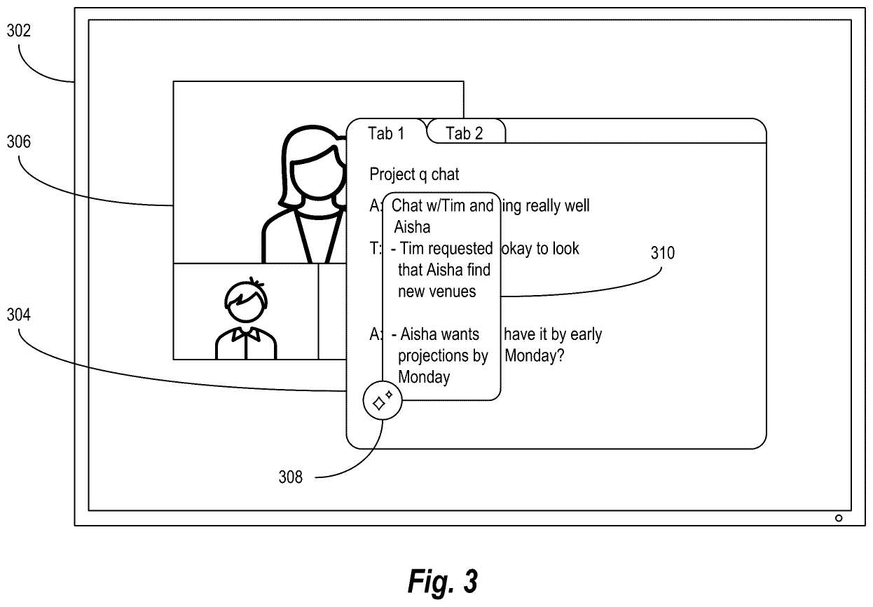

As noted above, in certain embodiments, the task catalyst system 102 generates a task list from digital content presented by (or otherwise extracted from) a client device. In particular, the task catalyst system 102 extracts tasks from digital content depicted within an active interface window displayed on a client device. FIG. 3 illustrates an example active interface window for extracting a task list in accordance with one or more embodiments.

As illustrated in FIG. 3, a client device 302 displays or presents a first application window 304 (for a first computer application) and a second application window 306 (for a second computer application). The task catalyst system 102 analyzes the operating system running on the client device 302 and/or otherwise analyzes the first application window 304 and the second application window 306 to determine which (if any) is an active application window. For instance, the task catalyst system 102 determines that the first application window 304 is using more processing power, more memory, and/or received the most recent user interaction to make it an active window. Accordingly, task catalyst system 102 generates and provides a catalyst bauble 308 for display to accompany the first application window 304.

As shown, the first application window 304 is for a web browser with multiple tabs. Not only does the task catalyst system 102 determine that the first application window 304 is an active application window, but the task catalyst system 102 further determines that Tab 1 as active tab within the browser and that Tab 2 is an inactive tab. Thus, the task catalyst system 102 provides the catalyst bauble 308 to accompany the active tab within the web browser. Within Tab 1, the user account associated with the client device 302 is participating in “Project q chat” by chatting with other user accounts, one for Tim and one for Aisha. Upon user interaction for switching tabs and/or application windows, the task catalyst system 102 can move the catalyst bauble 308 to whichever tab/window is currently active.

In response to a user interaction selecting the catalyst bauble 308, the task catalyst system 102 generates and provides a task list 310 for display. Specifically, the task catalyst system 102 scans digital content depicted within the first application window 304 and generates a text representation of the digital content. In some cases, the task catalyst system 102 utilizes a content conversion model to generate a text representation of digital content that includes images, videos, graphs, charts, or other non-text content. For instance, the task catalyst system 102 utilizes a content conversion model as described in U.S. patent application Ser. No. 18/469,357 titled GENERATING LARGE LANGUAGE MODEL OUTPUTS FROM STORED CONTENT ITEMS, filed Sep. 18, 2023, which is hereby incorporated by reference in its entirety.

The task catalyst system 102 further generates a task generation prompt which includes a text request for extracting tasks along with the text representation of the digital content. For example, the task catalyst system 102 generates a task generation prompt that includes a text representation of the “Project q chat” along with a text request to generate a task list. In some cases (e.g., where a large language model can process images, videos, and other non-text content), the task catalyst system 102 provides the text request along with non-text (e.g., original, unconverted) forms of depicted digital content. In either case, the task catalyst system 102 provides the prompt to a large language model and thus causes the large language model to generate the task list 310. As shown, the task list 310 includes tasks synthesized from the depicted digital content, such as “Tim requested an email reminder” and “Aisha wants projections by Monday.” In some embodiments, the task catalyst system 102 generates a task list to only include extracted tasks indicating calls to action for the user account of the client device 302 (ignoring other calls to action or indicating them as tasks for other user accounts).

In some embodiments, the task catalyst system 102 can generate other task lists as well. For instance, the task catalyst system 102 can generate a task list for each tab within the first application window 304 and/or for each application window (e.g., one for the first application window 304 and one for the second application window 306). For instance, the task catalyst system 102 can generate tasks lists for active application windows and/or for inactive application windows as well (e.g., in response to a single selection of the catalyst bauble 308). In some cases, the task catalyst system 102 determines overarching goals or projects for respective tasks lists and combines goal-related tasks extracted from different application windows into common task lists. For example, the task catalyst system 102 can generate a task list that includes a first task from the first application window 304 and a second task from the second application window 306 based on determining that the first task and the second task correspond to the same goal.

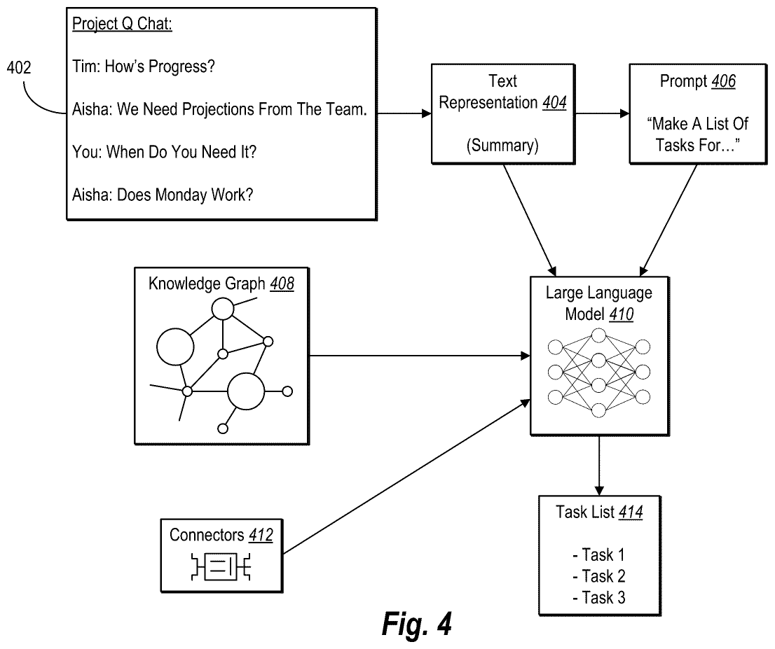

As mentioned above, in certain embodiments, the task catalyst system 102 utilizes a large language model to generate a task list. In particular, the task catalyst system 102 utilizes a large language model informed by digital content extracted from one or more application windows as well as contextual data sources, such as a knowledge graph and/or various connectors. FIG. 4 illustrates an example diagram for utilizing a large language model to generate a task list in accordance with one or more embodiments.

As illustrated in FIG. 4, the task catalyst system 102 identifies digital content 402. Indeed, the task catalyst system 102 identifies the digital content 402 as a content item depicted within (or extracted from) a display window presented on a client device. As shown, the digital content 402 is a chat window from a web browser or a chat application.

As also illustrated in FIG. 4, the task catalyst system 102 generates a text representation 404 of the digital content 402. For example, the task catalyst system 102 converts the digital content 402 to the text representation 404 using a content conversion model. Indeed, in some cases, the task catalyst system 102 converts a digital video, a digital image, and/or digital audio to a text-based format. In some embodiments, the task catalyst system 102 further utilizes a summarization model to generate the text representation 404 as a summary of the digital content 402. For example, the task catalyst system 102 summarizes the digital content 402 to shorten, truncate, or otherwise shrink the overall size of the data passed to the large language model 410. Reducing the data size (e.g., the character/token count) can preserve computational resources (and financial expense) when utilizing the large language model 410 to process the input prompt.

As further illustrated in FIG. 4, the task catalyst system 102 generates a prompt 406. More specifically, the task catalyst system 102 generates a prompt 406 that includes a natural language request for generating a task list from (e.g., where the language references) the text representation 404 (or from the digital content 402). For example, the task catalyst system 102 generates or utilizes a task generation prompt in the form of a pre-generated natural language query, such as “make a list of tasks for the accompanying data.” In some embodiments, the text representation 404 and the prompt 406 combine to form a task generation prompt. Either way, the task catalyst system 102 provides the text representation 404 and the prompt 406 to the large language model 410.

In turn, the large language model 410 generates a task list 414. More specifically, the large language model 410 analyzes the text representation 404 and/or the digital content 402 to identify action items and other content that corresponds to tasks within the digital content. Indeed, the large language model 410 summarizes or synthesizes the text representation 404 and/or the digital content 402 into the task list 414, omitting portions of content that do not include calls to action and summarizing those portions that include calls to action as tasks within the task list 414.

In one or more embodiments, the task catalyst system 102 utilizes contextual data to inform the process of generating the task list 414. More particularly, the task catalyst system 102 utilizes a knowledge graph 408 to generate the task list 414 based on relationships between user accounts and/or content items. For example, the task catalyst system 102 can determine that digital content 402 is from a computer application that the user account frequently uses to chat with co-user accounts about work and other projects and/or that the digital content 402 relates to a topic (or a goal or a project) common among multiple content items of the user account (e.g., “Project Q”). As another example, the task catalyst system 102 can determine that the user accounts in the chat of the digital content 402 are co-users belonging to a collaborative group or team within the content management system 106. The task catalyst system 102 can thus generate the task list 414 specific to the group of user accounts and specific to the topic of “Project Q.”

As part of generating the task list 414, the task catalyst system 102 can also prioritize or order the listed tasks based on relationships to content items and/or other user accounts. For instance, the task catalyst system 102 can order tasks within the task list based on which user account is requesting the task, where the knowledge graph 408 indicates that one requesting account is a supervisor/administrator account within an organizational ontology and another requesting user account is not. Thus, the task catalyst system 102 orders tasks from the supervisor account above tasks from the other user account. Along these lines, the task catalyst system 102 can generate the task list 414 for a particular goal by ordering tasks from content items more closely related (e.g., more frequently accesses or modified) to the user account above tasks from less related content items.

Additionally, the task catalyst system 102 can generate nodes within the knowledge graph 408 to represent tasks and projects. For instance, the task catalyst system 102 can determine semantic topics, related user accounts, scheduled execution times, geographic locations, and/or other data for various tasks and projects to define each node. The task catalyst system 102 can thus generate edges between the task nodes and project nodes to indicate their relationships to one another based on the various data. In some cases, the task catalyst system 102 can group tasks within a task list based on determining that their nodes are within a threshold distance (or a threshold degree of separation) apart within the knowledge graph 408 (and/or within a threshold distance/separation from a project node). In some embodiments, the task catalyst system 102 utilizes a knowledge graph as generated and implemented in U.S. patent application Ser. No. 18/414,996, titled GENERATING INTELLIGENT MEETING INSIGHTS FOR UPCOMING VIDEO CALLS, filed Jan. 17, 2024, which is hereby incorporated by reference in its entirety.

As also illustrated in FIG. 4, the task catalyst system 102 can utilize connectors 412 to inform the large language model in generating the task list 414. In some embodiments, a connector refers to a computer code segment, application, or program that retrieves or extracts features or metrics that define information from user-account-facing applications, such as digital calendars, video call applications, email applications, text messaging applications, and other applications. Indeed, the task catalyst system 102 can use the connectors 412 to bring in application context, such as usage metrics (e.g., frequency and recency of access) and/or calendar information for upcoming meetings or project deadlines. The task catalyst system 102 can thus generate the task list 414 by ordering tasks according to deadlines indicated by a calendar to accomplish the tasks on time. In some cases, a connector is as described by Vasanth Krishna Namasivayam et al. in U.S. patent application Ser. Nos. 18/478,061 and 18/478,066, each titled GENERATING AND MAINTAINING COMPOSITE ACTIONS UTILIZING LARGE LANGUAGE MODELS, filed Sep. 29, 2023, both of which are incorporated herein by reference in their entireties.

In one or more embodiments, the task catalyst system 102 utilizes a context engine to break down a multi-order prompt or query. For example, based on detecting that the prompt 406 is a higher-order prompt, the task catalyst system 102 provides the prompt 406 to a context engine to break down the prompt 406 into multiple lower-order prompts. In some cases, the task catalyst system 102 thus breaks down a higher-order prompt (e.g., a prompt that requests or defines multiple task lists) into multiple prompts that each correspond to (or cause the large language model 410 to generate) a single task list. The task catalyst system 102 thus provides each of the constituent prompts to the large language model 410 to generate a set of respective task lists. In certain embodiments, the task catalyst system 102 utilizes a context engine as described in U.S. patent application Ser. No. 18/303,496 titled GENERATING MULTI-ORDER TEXT QUERY RESULTS UTILIZING A CONTEXT ORCHESTRATION ENGINE, filed Apr. 28, 2023, and U.S. patent application Ser. No. 18/482,716 titled CUSTOM INTERPRETER FOR EXECUTING COMPUTER CODE GENERATED BY A LARGE LANGUAGE MODEL, filed Oct. 6, 2023, both of which are hereby incorporated by reference in their entireties.

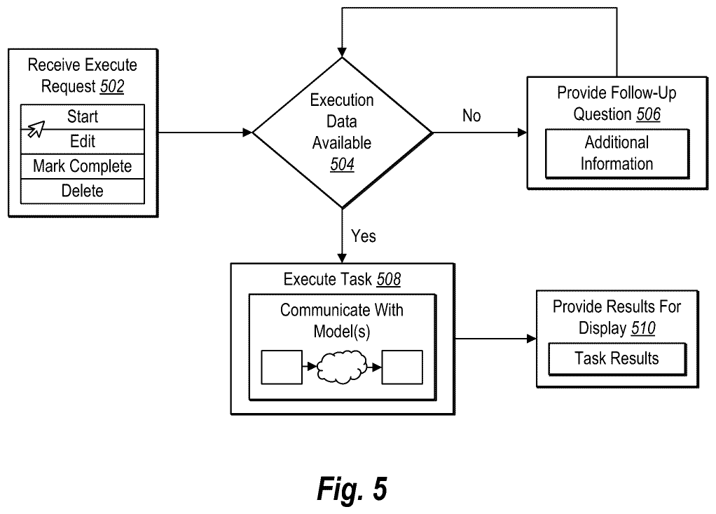

As noted above, in certain described embodiments, the task catalyst system 102 executes tasks within a task list. In particular, the task catalyst system 102 utilizes a task catalyst application to automatically execute tasks without require user interaction with separate computer applications (e.g., outside of the task catalyst application) and/or with a single click within the task catalyst application. FIG. 5 illustrates an example diagram for executing tasks of a task list in accordance with one or more embodiments.

As illustrated in FIG. 5, the task catalyst system 102 performs an act 502 to receive an execute request. More particularly, the task catalyst system 102 receives an indication of user interaction within a task catalyst application to execute a task within a task list. In some cases, the task catalyst system 102 receives a request to execute multiple tasks in order (e.g., all tasks in a task list), and the task catalyst system 102 processes each task in turn. As shown, the task catalyst system 102 receives a selection to “start” a task included within a task list.

In response to the request, the task catalyst system 102, the task catalyst system 102 performs an act 504 to determine whether execution data is available. Specifically, the task catalyst system 102 determines execution data that is required to execute the requested task. The task catalyst system 102 further compares the required execution data with available execution data, such as data included within the (text representation of the) digital content from which the task list was generated, from a knowledge graph and/or from one or more connectors (e.g., to indicate calendar data or other contextual data for stored content items of a user account). To determine whether the execution data is available, the task catalyst system 102 can generate a predicted preliminary output using a large language model, along with a confidence associated with the predicted output. If the confidence fails to satisfy a confidence threshold, the task catalyst system 102 determines that the execution data is lacking or not available.

Based on determining that the execution data is lacking or not available, the task catalyst system 102 performs an act 506 to provide a follow-up question. To elaborate, the task catalyst system 102 utilizes a large language model to generate a question that prompts a response from a client device to provide execution data. Indeed, the task catalyst system 102 generates a follow-up question to gather additional information for executing the task. As an example, the task catalyst system 102 generates a follow-up question of “I need some more information to generate the sales forecast for Q1. Which co-user accounts have access to past sales data?” In this example, the task catalyst system 102 cannot access past sales data to generate a prediction or a forecast of future sales data (e.g., because the user account has not granted access permission to the task catalyst application and/or because the user account does not have access to the content items). The task catalyst system 102 thus prompts the user account to provide a network location or a user account which the task catalyst system 102 can access or request permission to access for generating the forecast and executing the task. The task catalyst system 102 can thus receive the response from the client device, repeat the act 504 and the act 506, continuing until identifying the necessary execution data.

As further illustrated in FIG. 5, based on determining that the execution data is available, the task catalyst system 102 performs an act 508 to execute a task. Indeed, the task catalyst system 102 executes the task using the execution data by utilizing or communicating with one or more models, such as models internal to the content management system 106 and/or models external to the content management system 106. In some cases, executing a single task requires a single model. In other cases, executing a single task requires multiple models. Either way, the task catalyst system 102 identifies the model(s) capable of executing a task, provides execution data to the model(s), and orchestrates execution of the task using the model(s).

To execute a task, the task catalyst system 102 can utilize a large language model to generate a call to an application programming interface (API). For example, the task catalyst system 102 can provide a prompt for generating an API call for a computer application identified for executing the task. In some cases, the task catalyst system 102 instructs the large language model to generate an API call to generate a particular content item, modify an application, generate and send a digital communication, or perform some other task via an identified executing application. Specifically, the task catalyst system 102 can utilize a context engine (as described in U.S. patent application Ser. Nos. 18/303,496 and 18/482,716) to generate API calls for executing tasks using internal and/or external models or applications.

In some embodiments, to execute a task, the task catalyst system 102 can utilize a large language model to directly perform processes or functions within native applications in the foreground. To elaborate, the task catalyst system 102 can instruct a large language model to generate executable computer code in the form of function calls (e.g., for operating systems and/or computer applications) to manipulate an executing application. Indeed, the task catalyst system 102 can perform direct application manipulation for task execution by using a large language model to generate function calls for (automating by circumventing user input to perform) actions such as clicks, text input, or other interactions with computer applications for task execution.

Continuing the above example of generating a sales forecast for Q1, the task catalyst system 102 identifies a model or a system to access content items stored in a network location indicating past sales data. The task catalyst system 102 further generates and provides computer code to the model/system to instruct the model/system to access indicated content items including past sales data. Additionally, the task catalyst system 102 identifies a machine learning model (e.g., a neural network) that is trained to predict sales forecasts from past sales data. The task catalyst system 102 thus provides the extracted past sales data to the model along with computer code instructing the model to generate a predicted forecast for Q1. The task catalyst system 102 accordingly executes the task using two different models, passing data generated from one to perform processes of the other. In some embodiments, the task catalyst system 102 generates the computer code instructions for utilizing various models (including passing data between models) using a large language model.

As further illustrated in FIG. 5, based on executing the task via one or more (external or internal) models, the task catalyst system 102 performs an act 510 to provides results for display. Indeed, the task catalyst system 102 can generate a catalyst interface (as part of the task catalyst application) to present a task list for display on a client device. The task catalyst system 102 can generate different variations of a catalyst interface for generating task lists, reviewing task lists, executing tasks, monitoring task progress, and performing other operations.

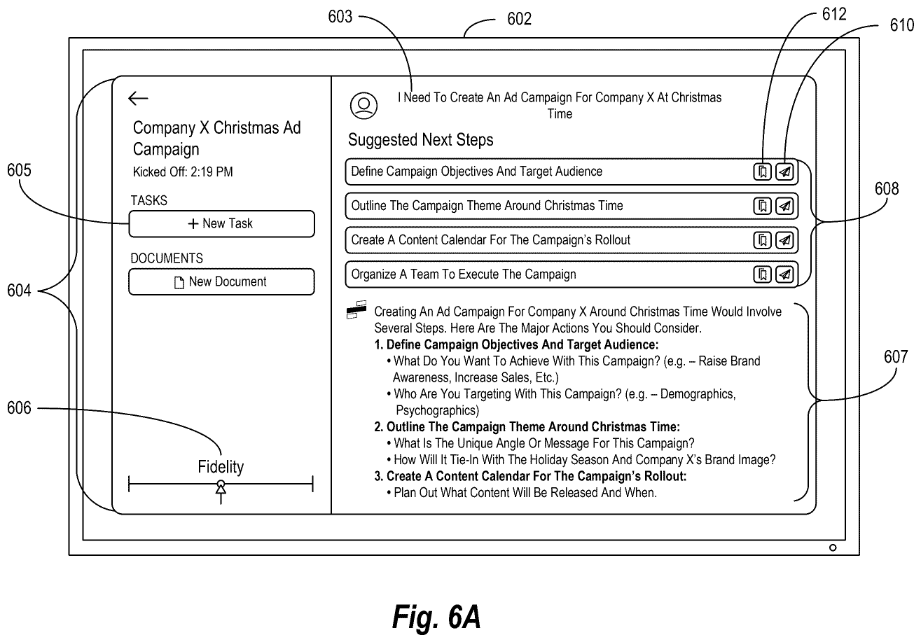

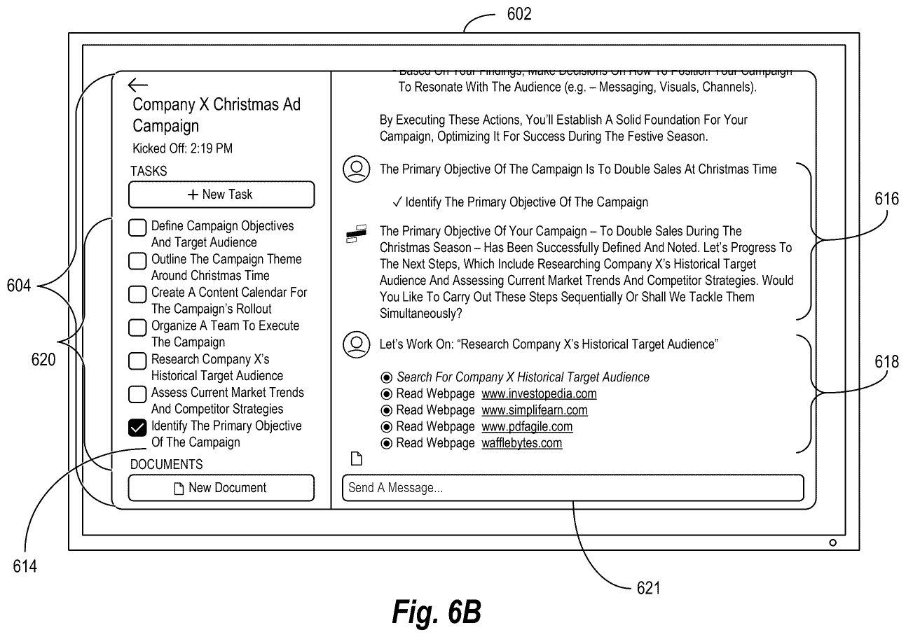

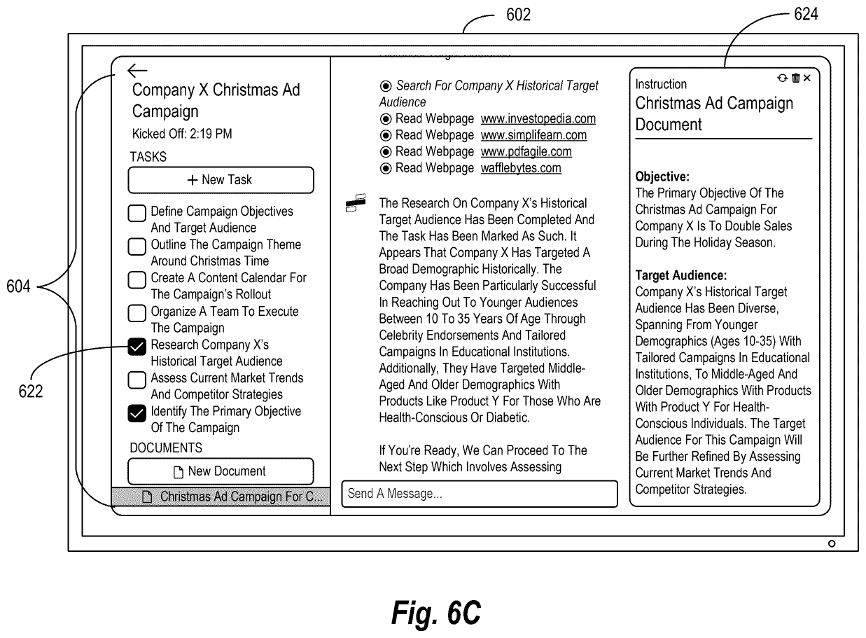

As just mentioned, the task catalyst system 102 can generate a catalyst interface for display on a client device. In particular, the task catalyst system 102 can generate a catalyst interface for generating and executing tasks utilizing a large language model. FIGS. 6A-6C illustrate an example catalyst interface and various operations performable from the catalyst interface in accordance with one or more embodiments.

As illustrated in FIG. 6A, the task catalyst system 102 generates and provides a catalyst interface 604 for display on a client device 602. Within the catalyst interface 604, the task catalyst system 102 provides an indication of a text prompt 603. In response to receiving the text prompt 603 via user interaction with the client device 602, the task catalyst system 102 can combine the text prompt 603 with (a text representation of) digital content scanned from one or more application windows on the client device 602 (and/or stored within one or more network locations associated with a user account). By combining the text prompt 603 with digital content, the task catalyst system 102 generates a task generation prompt to provide to a large language model.

The task catalyst system 102 further provides the task generation prompt to the large language model to generate a task list 608. Indeed, in response to the text prompt “I need to create an ad campaign for Company X and Christmas time,” the task catalyst system 102 generates (or causes an external large language model to generate) the task list 608, each task in the task list 608 corresponds to a common overarching goal or project (e.g., “Company X Christmas Ad Campaign”). The task catalyst system 102 provides the task list 608 for display within an observation pane of the catalyst interface 604 (e.g., to the right of the vertical line dividing the catalyst interface 604). As shown, task list 608 includes four tasks that are each executable independently. As also shown, the task catalyst system 102 generates and provides a description 607 for one or more of the tasks within the task list 608. Indeed, the description 607 provides details for the purpose of each task and/or how each task should be executed.

Further within the observation pane of the catalyst interface 604, the task catalyst system 102 provides user interface elements to perform various functions. For example, the task catalyst system 102 provides a save element 612 that is selectable to save a task from the task list 608. In response to a selection of the save element 612, the task catalyst system 102 saves the task for execution and adds the task to the task pane within the catalyst interface 604 (left of the vertical line separating the catalyst interface). In some embodiments, the task catalyst system 102 provides a save-all element that is selectable to save the entire task list 608 with a single click.

As shown, the task catalyst system 102 also provides a send element 610 that is selectable to send or share a task within the task list 608. For example, in response to a selection of the send element 610, the task catalyst system 102 can send or provide a task to one or more other client devices associated with co-user accounts. In some cases, the task catalyst system 102 identifies and flags a task meant for another user account. Indeed, the task catalyst system 102 can identify the appropriate user account for executing the task. Thus, in response to a send request, the task catalyst system 102 can send the task to the appropriate user account within the content management system 106.

As further shown in FIG. 6A, the task catalyst system 102 provides a new task element 605. In particular, the task catalyst system 102 provides the new task element 605 as a selectable interface element for generating a new task. For instance, the task catalyst system 102 can generate or define a task from manual user input. Particularly, the task catalyst system 102 can receive input defining a task to include or add to a task list.

Additionally, the task catalyst system 102 can provide a fidelity adjuster 606. Specifically, the task catalyst system 102 can provide the fidelity adjuster 606 as an interactive element with a slider to modify a granularity or a fidelity of extracted tasks. For example, based on increasing a fidelity, the task catalyst system 102 generates or extracts tasks at a higher level of detail or at an increased granularity (generally resulting in more tasks within a task list). Conversely, based on a decreased fidelity, the task catalyst system 102 generates or extracts tasks at a lower level of detail or at a decreased granularity (generally resulting in fewer tasks). Higher fidelity/granularity tasks generally have fewer steps and/or utilize fewer models than lower fidelity/granularity tasks which are more general in nature and may require multiple processes or models to execute.

In some embodiments, the task catalyst system 102 utilizes the context engine described above to modify the fidelity of extracting tasks from digital content. For example, the task catalyst system 102 utilizes a context engine to determine that a task is dividable into smaller nested tasks and/or for determining that tasks are combinable into larger tasks. Specifically, the task catalyst system 102 determines that a task is dividable based on determining that the task includes multiple models and/or multiple processes to execute. In some cases, a single-process (or single-model) task is not dividable. The task catalyst system 102 determines that two or more tasks are combinable based on determining that the tasks relate to a common overarching goal or project. Indeed, the task catalyst system 102 can implement a content engine as described in U.S. patent application Ser. Nos. 18/303,496 and 18/482,716 to break down existing tasks and/or to analyze scanned digital content to generate tasks at an indicated fidelity. The task catalyst system 102 can thus generate or modify a task list based on an indicated fidelity.

As mentioned above, the task catalyst system 102 can save tasks within the task pane for execution based on receiving a selection of a save element. As illustrated in FIG. 6B, the catalyst interface 604 includes a task list 620 saved from the task list 608 in FIG. 6A. Indeed, the task catalyst system 102 saves the task list 620 into the task pane for executing and managing the tasks. For instance, the task catalyst system 102 receives an indication of a selection of an execute element (e.g., within a right-click menu for a particular task in the task list 620 and/or as a standalone execute element) and executes the corresponding task. Once a task is executed, the task catalyst system 102 marks the task as complete (e.g., with a check mark) within the task pane and provides an explanation of the execution in the observation pane.

To elaborate, the task catalyst system 102 executes the task 614 and, upon completion of the execution process, marks the task 614 as complete. As part of the execution process, the task catalyst system 102 also generates an execution summary 616 for the task 614. Indeed, the task catalyst system 102 provides an observation function within the observation pane to monitor or observe the processes performed by the task catalyst system 102 (using various internal and/or external models and data sources) as part of executing the task 614. As shown, the task catalyst system 102 receives input from the client device 602 to define the primary objective of the campaign—“The primary objective of the campaign is to double sales at Christmas time.”

Based on the received input, the task catalyst system 102 determines that the task 614 is accomplished and thus marks the task 614 as complete. As part of the observation function, the task catalyst system 102 generates and provides the execution summary 616 to indicate that the task 614 is completed, how the task 614 was completed, and/or to prompt execution of additional tasks in the task list 620. As shown in the execution summary 618, the task catalyst system 102 queries the user account to indicate a next task to execute and/or to execute multiple tasks simultaneously. Indeed, the task catalyst system 102 can execute multiple tasks simultaneously in parallel upon determining that none of the parallelly executed tasks rely on one another.

As further illustrated in FIG. 6B, the task catalyst system 102 receives user interaction requesting execution of an additional task—“Let's work on: ‘Research Company X's historical target audience.’” For example, the task catalyst system 102 receives the input of the task execution request in the form of a prompt provided via the prompt element 621. As another example, the task catalyst system 102 receives a selection of an execution element for a task within the task list 620. In response to the execution request, the task catalyst system 102 identifies a corresponding task within the task list 620 and performs one or more processes for its execution.

As part of the observation function, the task catalyst system 102 further generates and provides an execution summary 618 explaining or summarizing the execution processes of the task. For instance, the task catalyst system 102 identifies a set of data sources, such as websites or other cloud-based data storage, which may include data relating to Company X's historical target audience. As shown, the task catalyst system 102 further performs a web search to determine if a search engine can produce information regarding Company X's historical target audience. Accordingly, through the observation function, the task catalyst system 102 provides monitoring capabilities to track progress of task execution, including each process performed within the task.

Along with the observation function, the task catalyst system 102 can also provide an interrupt function. To elaborate, the task catalyst system 102 can provide selectable elements (e.g., the prompt element 621 or some other element) for interrupting execution of a task. Indeed, the task catalyst system 102 can pause and resume task execution using an interrupt function. In some cases, the task catalyst system 102 can receive a modification to execution data (e.g., where a user account provides additional information and/or indicates a new storage location for the task catalyst system 102 to find data for executing a task) for modifying execution of a task. Upon resuming or restarting execution, the task catalyst system 102 can use the new or modified execution data.

In some embodiments, the task catalyst system 102 can analyze new digital content to generate new tasks. For example, the task catalyst system 102 can generate the task list 620 from a first content item and can generate an additional task list from another content item. Over time, the task catalyst system 102 can thus generate many different tasks lists for various goals or projects of a user account. As part of this process, the task catalyst system 102 can compare newly extracted tasks to existing task lists or projects. Upon determining that a newly extracted task corresponds to an existing project (e.g., based on semantic topic comparison and/or a comparison of other knowledge graph data described above), the task catalyst system 102 can automatically add the task to the task list of the project (or generate a notification prompting approval of adding the task to the task list). Conversely, upon determining that a newly extracted task does not correspond to an existing task list or project, the task catalyst system 102 can automatically (without prompting from a client device) execute the task and provide an indication of execution within the task pane of the catalyst interface 604 (without generating an execution summary).

As noted above, in certain embodiments, the task catalyst system 102 can continue to execute tasks within the task list 620, summarizing the execution process and marking them as they are completed along the way. As illustrated in FIG. 6C, the task catalyst system 102 continues the process of executing the task 622 started in FIG. 6B to research Company X's historical target audience. As shown, the task catalyst system 102 completes the processes of using a search engine and reading/analyzing a series of webpages to execute the task 622. Upon completing the task 622, the task catalyst system 102 marks the task 622 as complete (with a check mark) the task pane of the catalyst interface 604. In addition, the task catalyst system 102 generates a summary explanation of the task execution.

As further illustrated in FIG. 6C, the task catalyst system 102 generates and provides a project summary 624 within the catalyst interface 604. To elaborate, the task catalyst system 102 generate the project summary 624 by titling and summarizing executed tasks from the task list 620. For example, the task catalyst system 102 executes a task, and upon execution, generates a header/title for the task and further generates a summary of the outcome, response, or result from the task. As shown, the task catalyst system 102 generates the project summary 624 to include a title of “Objective” for the task 614 and the title “Target Audience” for the task 622. The task catalyst system 102 can utilize a large language model to generate the project summary 624, including the title and the summary of each task. Indeed, the task catalyst system 102 can utilize a large language model to generate a project name (“Christmas Ad Campaign Document”), generate a task title, and generate a task summary to include within the project summary 624.

In one or more embodiments, the task catalyst system 102 generates the project summary 624 as a standalone digital document that is save-able and/or otherwise interactive. Indeed, the task catalyst system 102 can generate a digital document (or some other type of content item) for a project (or a task) that indicates or includes the information generated by executing tasks in a task list for the project.

In some cases, the task catalyst system 102 can further modify tune or train one or more models of the task catalyst application (e.g., catalyst models in the form of large language models) based on feedback in relation to the generated digital document (e.g., the project summary 624). For instance, the task catalyst system 102 can receive positive feedback, such as a thumbs-up indicator designating the generated document (or other task execution output) as a good result. As another form of positive feedback, the task catalyst system 102 can detect an interaction to save the generated document and/or can monitor access or modification of the generated document. On the other hand, if the generated document goes un-accessed and/or receives other negative feedback (e.g., a thumbs down or a delete action), the task catalyst system 102 can mark the generated document as a bad result. Based on the positive and negative feedback, the task catalyst system 102 can update parameters of models within the task catalyst application, including large language models to generate increasingly accurate and useful outputs over time. Indeed, the task catalyst system 102 can update parameters to skew outputs toward results that yield positive feedback and away from results that yield negative feedback.

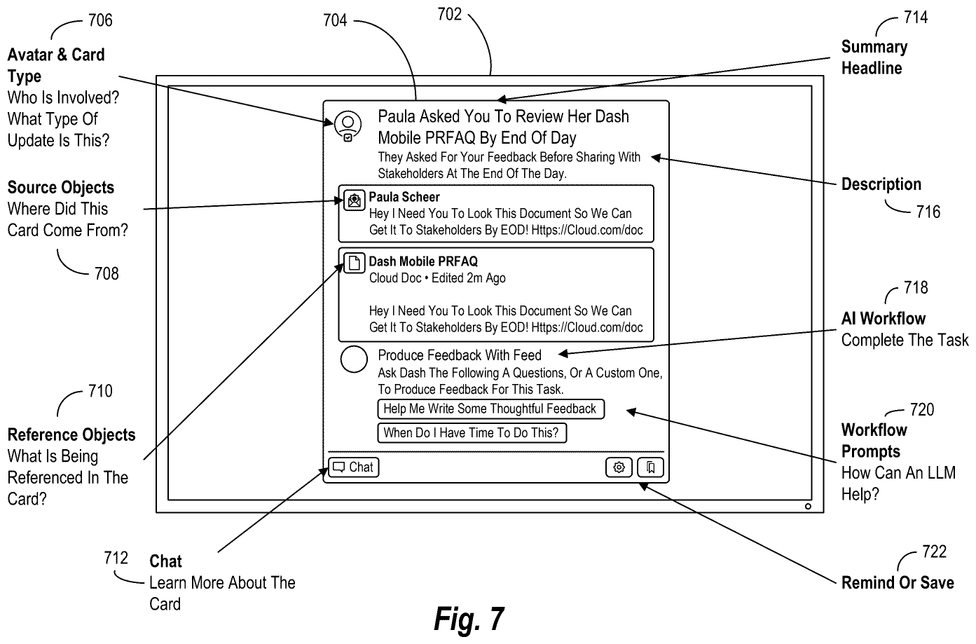

As mentioned above, in certain described embodiments, the task catalyst system 102 provides a catalyst interface in the form of a feed card. In particular, the task catalyst system 102 generates and perpetually updates a feed card to indicate tasks and task execution over time. FIG. 7 illustrates a feed card for a particular user account in accordance with one or more embodiments.

As illustrated in FIG. 7, the task catalyst system 102 generates and provides a feed card 704 for display on a client device 702. Within the feed card 704, the task catalyst system 102 provides various interface elements. For example, the task catalyst system 102 determines a card type and provides a card type indicator 706 for display. In some cases, the task catalyst system 102 determines the card type by determining a project associated with the card and/or identifying a task list corresponding to the project. The task catalyst system 102 can categorize projects into different types (e.g., work, personal, and/or from a particular requesting account or group) and/or based on priority levels and can reflect a category with the card type indicator 706. For instance, if a project originates from a request by a supervisor or manager user account, the task catalyst system 102 can generate the card type indicator 706 to indicate a higher priority level and/or to reflect an avatar of the requesting account.

As shown, the task catalyst system 102 also provides source object indicators 708. In particular, the task catalyst system 102 identifies a source object by determining a computer application, a data storage location, and/or a specific application window where the data for the feed card 704 originates. To elaborate, the task catalyst system 102 determines the source of the digital content that is scanned to extract a task list. As shown, the task catalyst system 102 identifies a shared cloud document between user accounts as the source for the feed card 704 and thus generates the source object indicators 708 to reference the cloud document.

Additionally, the task catalyst system 102 generates and provides reference object indicators 710. The task catalyst system 102 determines a reference object by determining a computer application, a website, or a network location where the task catalyst system 102 accesses data for executing a task. For instance, the task catalyst system 102 designates a reference object as an object that includes execution data referenced by a task in a source object. In some cases, a reference object can indicate additional tasks for extraction to add to the task list of the feed card 704. The task catalyst system 102 thus provides the reference object indicators 710 to indicate or define the reference object.

As further illustrated in FIG. 7, the task catalyst system 102 generates a chat element 712. Upon selection of the chat element 712, the task catalyst system 102 can utilize a large language model to receive queries and generate responses. Indeed, the task catalyst system 102 can chat with a user account to answer questions regarding the feed card 704 and/or a specific task in the feed card 704. The task catalyst system 102 can generate responses utilizing a large language model to process data associated with the feed card 704, including the overall project, tasks, source objects, and reference objects in their various network locations.

In addition, the task catalyst system 102 generates and provides a summary headline 714. For example, the task catalyst system 102 generates the summary headline 714 by utilizing a large language model to analyze a source object for the project corresponding to the feed card 704. Through the analysis, the task catalyst system 102 generates a title or a header describing or defining the project specific to the feed card 704. The task catalyst system 102 thus generates (via a large language model) the summary headline 714 as a project title or a header for the feed card 704.

As also shown in FIG. 7, the task catalyst system 102 generates a description 716 to accompany the summary headline 714. Specifically, the task catalyst system 102 utilizes a large language model to generate the description 716 as a summary or a description of the project associated with the feed card 704. The task catalyst system 102 can generate the description 716 by processing data from a source object and/or from one or more reference objects.

As further shown, the task catalyst system 102 generates an AI workflow 718. Particularly, the task catalyst system 102 generates the AI workflow 718 as a visual representation of processes or operations performed (or yet to be performed) to execute a task for the project. Indeed, the task catalyst system 102 generates the AI workflow as part of an observation function to monitor execution of a task. In some cases, task execution involves using one or more models, and the AI workflow 718 can indicate the various artificial intelligence (AI) models and/or other models used with respect to each process of a task.

Additionally, the task catalyst system 102 generates and provides workflow prompts 720. Indeed, the task catalyst system 102 generates a workflow prompt by using a large language model to generate suggestions for additional tasks and/or suggestions for next steps after task execution. For example, the task catalyst system 102 analyzes a task, a source object, and/or a reference object to generate a workflow prompt that suggests a follow-up action after executing the task. In some cases, each of the workflow prompts 720 corresponds to a respective task suggested based on execution of an existing task. Upon selection of a workflow prompt, the task catalyst system 102 can add a corresponding task to the task list of the feed card 704 for executing via a large language model.

Further, the task catalyst system 102 provides remind or save elements 722. Specifically, the task catalyst system 102 provides interface elements for saving the feed card 704 (or for saving an output generated from executing a particular task or task list for the corresponding project). Based on an interaction to save the feed card 704 (or another task output), the task catalyst system 102 can treat the save action as positive feedback for updating parameters. Similarly, the task catalyst system 102 can treat a remind action (e.g., a selection of a remind element) as positive feedback for updating model parameters. In some cases, the task catalyst system 102 treats a save action as more positive than a remind action and modifies model parameters accordingly to more heavily skew toward most positive results and less heavily skew toward less positive results.

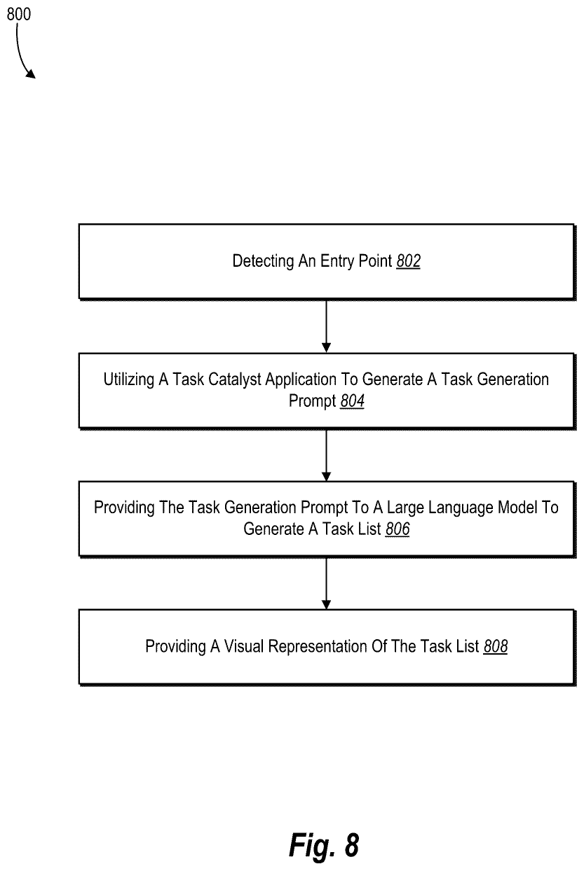

FIGS. 1-7, the corresponding text, and the examples provide a number of different systems and methods for generating, providing, and executing tasks using a task catalyst application. In addition to the foregoing, implementations can also be described in terms of flowcharts comprising acts steps in a method for accomplishing a particular result. For example, FIG. 8 illustrates an example series of acts for generating, providing, and executing tasks using a task catalyst application in accordance with one or more embodiments.

While FIG. 8 illustrates acts according to certain implementations, alternative implementations may omit, add to, reorder, and/or modify any of the acts shown in FIG. 8. The acts of FIG. 8 can be performed as part of a method. Alternatively, a non-transitory computer readable medium can comprise instructions, that when executed by one or more processors, cause a computing device to perform the acts of FIG. 8. In still further implementations, a system can perform the acts of FIG. 8.

As illustrated in FIG. 8, the series of acts 800 may include an act 802 of detecting an entry point. In particular, the act 802 involves detecting an entry point trigger for initializing a task catalyst application on a client device. In addition, the series of acts 800 includes an act 804 of utilizing a task catalyst application to generate a task generation prompt. In particular, the act 804 involves, in response to the entry point trigger, utilizing the task catalyst application to generate, from digital content depicted within an application window presented on the client device, a task generation prompt defining a request to generate a task list from the digital content depicted within the application window. As shown, the series of acts 800 includes an act 806 of providing the task generation prompt to a large language model to generate a task list. In particular, the act 806 involves providing the task generation prompt and the digital content to a large language model for generating the task list. In some cases, the act 806 involves causing a large language model to generate the task list from the digital content in response to the task generation prompt. Further, the series of acts 800 includes an act 808 of providing a visual representation of the task list. In particular, the act 808 involves providing, for display on the client device, a visual representation of the task list generated by the large language model. In some cases, the act 808 involves providing, for display on the client device, a catalyst interface corresponding to the task list generated by the large language model.

In some embodiments, the series of acts 800 includes an act of providing, for display on the client device, a catalyst bauble that follows client device interactions across computer applications to accompany an active interface window displayed on the client device. Detecting the entry point trigger can include detecting a selection of the catalyst bauble to initiate scanning of the active interface window for tasks to include within the task list.

Additionally, the series of acts 800 can include an act of generating the task generation prompt by utilizing the catalyst application to: scan the digital content depicted within the application window to generate a text representation of the digital content and generate a natural language request for generating the task list by generating terminology requesting task generation from the text extracted of the digital content. Further, the series of acts 800 can include an act of, in response to the task generation prompt, causing the large language model to generate the task list by analyzing the terminology of the natural language request and the text representation of the digital content.

In one or more embodiments, the series of acts 800 includes an act of providing the visual representation of the task list by providing, for display on the client device, a catalyst interface depicting at least one task within the task list, an indication of an overall objective associated with the task list, and a target audience associated with the task list. The series of acts 800 can also include an act of providing, for display on the client device, a fidelity adjuster selectable to modify a fidelity of task generation from the digital content and an act of, in response to user interaction with the fidelity adjuster to set a modified fidelity, modifying the task list to include a different number of tasks according to the modified fidelity.

Further, the series of acts 800 can include an act of receiving a request from the client device to break down a task within the task list into additional tasks. In addition, the series of acts 800 can include an act of, response to the request, generating, for the task, nested tasks that indicate actions at an increased level of granularity as compared to the task within the task list. The series of acts 800 can also include acts of receiving, from the client device, a request to execute a task with the task list and, in response to the request, executing the task by communicating with one or more external models connected to the catalyst application.

The series of acts 800 can include an act of generating the task list by providing contextual information from a knowledge graph to the large language model to inform task extraction based on relationships among user accounts. The series of acts 800 can also include an act of determining, in response to a request to execute a task with the task list, that additional information is needed to execute the task. Further, the series of acts 800 can include an act of generating a follow-up question to provide to the client device prompting a response to indicate the additional information.

In some embodiments, the series of acts 800 includes an act of identifying an additional task by utilizing the catalyst application to analyze additional digital content depicted within a new application window presented on the client device. In these or other embodiments, the series of acts 800 includes an act of determining that the additional task relates to the task list generated from the digital content. Further, the series of acts 800 can include an act of adding the additional task to the task list in response to determining that the additional task relates to the task list.

Additionally, the series of acts 800 can include acts of identifying an additional task by utilizing the catalyst application to analyze additional digital content depicted within a new application window presented on the client device, determining that the additional task does not relate to a previously generated task list, and automatically executing the additional task based on determining that the additional task does not relate to a previously generated task list. The series of acts 800 can include an act of detecting the entry point trigger by detecting one or more of: a client device interaction with a catalyst bauble provided for display to accompany the application window presented on the client device or audio data indicating a task from a virtual meeting that includes the client device.

The series of acts 800 can include an act of generating the task list by utilizing the catalyst application to: generate the task generation prompt to include a text representation of the digital content depicted within the application window presented on the client device and generate the task generation prompt to include a text representation of audio data captured from a virtual meeting that includes the client device. In some cases, the series of acts 800 includes acts of receiving, from the client device, an indication of positive feedback for the task list generated by the large language model and adjusting parameters of the large language model based on the indication of positive feedback.

Additionally, the series of acts 800 can include an act of executing a task within the task list by utilizing the catalyst application to communicate with one or more external computer applications and an act of providing, for display on the client device, a visual representation of one or more data sources used to execute the task via the one or more external computer applications. The series of acts 800 can include an act of performing an observation function for presenting, for display on the client device, a visualization of the catalyst application executing one or more tasks within the task list. The series of acts 800 can include an acts of receiving, from the client device, an indication to interrupt execution of a task from the task list and in response to the indication, interrupting execution of the task to change task execution parameters before resuming execution of the task.

The components of the task catalyst system 102 can include software, hardware, or both. For example, the components of the task catalyst system 102 can include one or more instructions stored on a computer-readable storage medium and executable by processors of one or more computing devices. When executed by one or more processors, the computer-executable instructions of the task catalyst system 102 can cause a computing device to perform the methods described herein. Alternatively, the components of the task catalyst system 102 can comprise hardware, such as a special purpose processing device to perform a certain function or group of functions. Additionally or alternatively, the components of the task catalyst system 102 can include a combination of computer-executable instructions and hardware.

Furthermore, the components of the task catalyst system 102 performing the functions described herein may, for example, be implemented as part of a stand-alone application, as a module of an application, as a plug-in for applications including content management applications, as a library function or functions that may be called by other applications, and/or as a cloud-computing model. Thus, the components of the task catalyst system 102 may be implemented as part of a stand-alone application on a personal computing device or a mobile device.

Embodiments of the present disclosure may comprise or utilize a special purpose or general-purpose computer including computer hardware, such as, for example, one or more processors and system memory, as discussed in greater detail below. Implementations within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, implementations of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some implementations, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multiprocessor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Implementations of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 9 illustrates a block diagram of exemplary computing device 900 (e.g., the server(s) 104 and/or the client device 108) that may be configured to perform one or more of the processes described above. One will appreciate that server(s) 104 and/or the client device 108 may comprise one or more computing devices such as computing device 900. As shown by FIG. 9, computing device 900 can comprise processor 902, memory 904, storage device 906, I/O interface 908, and communication interface 910, which may be communicatively coupled by way of communication infrastructure 912. While an exemplary computing device 900 is shown in FIG. 9, the components illustrated in FIG. 9 are not intended to be limiting. Additional or alternative components may be used in other implementations. Furthermore, in certain implementations, computing device 900 can include fewer components than those shown in FIG. 9. Components of computing device 900 shown in FIG. 9 will now be described in additional detail.

In particular implementations, processor 902 includes hardware for executing instructions, such as those making up a computer program. As an example and not by way of limitation, to execute instructions, processor 902 may retrieve (or fetch) the instructions from an internal register, an internal cache, memory 904, or storage device 906 and decode and execute them. In particular implementations, processor 902 may include one or more internal caches for data, instructions, or addresses. As an example and not by way of limitation, processor 902 may include one or more instruction caches, one or more data caches, and one or more translation lookaside buffers (TLBs). Instructions in the instruction caches may be copies of instructions in memory 904 or storage device 906.

Memory 904 may be used for storing data, metadata, and programs for execution by the processor(s). Memory 904 may include one or more of volatile and non-volatile memories, such as Random Access Memory (“RAM”), Read Only Memory (“ROM”), a solid state disk (“SSD”), Flash, Phase Change Memory (“PCM”), or other types of data storage. Memory 904 may be internal or distributed memory.

Storage device 906 includes storage for storing data or instructions. As an example and not by way of limitation, storage device 906 can comprise a non-transitory storage medium described above. Storage device 906 may include a hard disk drive (HDD), a floppy disk drive, flash memory, an optical disc, a magneto-optical disc, magnetic tape, or a Universal Serial Bus (USB) drive or a combination of two or more of these. Storage device 906 may include removable or non-removable (or fixed) media, where appropriate. Storage device 906 may be internal or external to computing device 900. In particular implementations, storage device 906 is non-volatile, solid-state memory. In other implementations, Storage device 906 includes read-only memory (ROM). Where appropriate, this ROM may be mask programmed ROM, programmable ROM (PROM), erasable PROM (EPROM), electrically erasable PROM (EEPROM), electrically alterable ROM (EAROM), or flash memory or a combination of two or more of these.

I/O interface 908 allows a user to provide input to, receive output from, and otherwise transfer data to and receive data from computing device 900. I/O interface 908 may include a mouse, a keypad or a keyboard, a touch screen, a camera, an optical scanner, network interface, modem, other known I/O devices or a combination of such I/O interfaces. I/O interface 908 may include one or more devices for presenting output to a user, including, but not limited to, a graphics engine, a display (e.g., a display screen), one or more output drivers (e.g., display drivers), one or more audio speakers, and one or more audio drivers. In certain implementations, I/O interface 908 is configured to provide graphical data to a display for presentation to a user. The graphical data may be representative of one or more graphical user interfaces and/or any other graphical content as may serve a particular implementation.

Communication interface 910 can include hardware, software, or both. In any event, communication interface 910 can provide one or more interfaces for communication (such as, for example, packet-based communication) between computing device 900 and one or more other computing devices or networks. As an example and not by way of limitation, communication interface 910 may include a network interface controller (NIC) or network adapter for communicating with an Ethernet or other wire-based network or a wireless NIC (WNIC) or wireless adapter for communicating with a wireless network, such as a WI-FI.

Additionally or alternatively, communication interface 910 may facilitate communications with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, communication interface 910 may facilitate communications with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination thereof.

Additionally, communication interface 910 may facilitate communications various communication protocols. Examples of communication protocols that may be used include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MMS”), radio frequency (“RF”) signaling technologies, Long Term Evolution (“LTE”) technologies, wireless communication technologies, in-band and out-of-band signaling technologies, and other suitable communications networks and technologies.

Communication infrastructure 912 may include hardware, software, or both that couples components of computing device 900 to each other. As an example and not by way of limitation, communication infrastructure 912 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination thereof.

FIG. 10 is a schematic diagram illustrating environment 1000 within which one or more implementations of the task catalyst system 102 can be implemented. For example, the task catalyst system 102 may be part of a content management system 1002 (e.g., the content management system 106). Content management system 1002 may generate, store, manage, receive, and send digital content (such as digital content items). For example, content management system 1002 may send and receive digital content to and from client devices 1006 by way of network 1004. In particular, content management system 1002 can store and manage a collection of digital content. Content management system 1002 can manage the sharing of digital content between computing devices associated with a plurality of users. For instance, content management system 1002 can facilitate a user sharing a digital content with another user of content management system 1002.

In particular, content management system 1002 can manage synchronizing digital content across multiple client devices 1006 associated with one or more users. For example, a user may edit digital content using client device 1006. The content management system 1002 can cause client device 1006 to send the edited digital content to content management system 1002. Content management system 1002 then synchronizes the edited digital content on one or more additional computing devices.

In addition to synchronizing digital content across multiple devices, one or more implementations of content management system 1002 can provide an efficient storage option for users that have large collections of digital content. For example, content management system 1002 can store a collection of digital content on content management system 1002, while the client device 1006 only stores reduced-sized versions of the digital content. A user can navigate and browse the reduced-sized versions (e.g., a thumbnail of a digital image) of the digital content on client device 1006. In particular, one way in which a user can experience digital content is to browse the reduced-sized versions of the digital content on client device 1006.

Another way in which a user can experience digital content is to select a reduced-size version of digital content to request the full- or high-resolution version of digital content from content management system 1002. In particular, upon a user selecting a reduced-sized version of digital content, client device 1006 sends a request to content management system 1002 requesting the digital content associated with the reduced-sized version of the digital content. Content management system 1002 can respond to the request by sending the digital content to client device 1006. Client device 1006, upon receiving the digital content, can then present the digital content to the user. In this way, a user can have access to large collections of digital content while minimizing the amount of resources used on client device 1006.

Client device 1006 may be a desktop computer, a laptop computer, a tablet computer, a personal digital assistant (PDA), an in- or out-of-car navigation system, a handheld device, a smart phone or other cellular or mobile phone, or a mobile gaming device, other mobile device, or other suitable computing devices. Client device 1006 may execute one or more client applications, such as a web browser (e.g., Microsoft Windows Internet Explorer, Mozilla Firefox, Apple Safari, Google Chrome, Opera, etc.) or a native or special-purpose client application (e.g., Dropbox Paper for iPhone or iPad, Dropbox Paper for Android, etc.), to access and view content over network 1004.

Network 1004 may represent a network or collection of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which client devices 1006 may access content management system 1002.

In the foregoing specification, the present disclosure has been described with reference to specific exemplary implementations thereof. Various implementations and aspects of the present disclosure(s) are described with reference to details discussed herein, and the accompanying drawings illustrate the various implementations. The description above and drawings are illustrative of the disclosure and are not to be construed as limiting the disclosure. Numerous specific details are described to provide a thorough understanding of various implementations of the present disclosure.

The present disclosure may be embodied in other specific forms without departing from its spirit or essential characteristics. The described implementations are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the present application is, therefore, indicated by the appended claims rather than by the foregoing description. All changes that come within the meaning and range of equivalency of the claims are to be embraced within their scope.

The foregoing specification is described with reference to specific exemplary implementations thereof. Various implementations and aspects of the disclosure are described with reference to details discussed herein, and the accompanying drawings illustrate the various implementations. The description above and drawings are illustrative and are not to be construed as limiting. Numerous specific details are described to provide a thorough understanding of various implementations.

The additional or alternative implementations may be embodied in other specific forms without departing from its spirit or essential characteristics. The described implementations are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A method comprising:
detecting an entry point trigger for initializing a task catalyst application on a client device;
in response to the entry point trigger, utilizing the task catalyst application to generate, from digital content depicted within an application window presented on the client device, a task generation prompt defining a request to generate a task list from the digital content depicted within the application window;
providing the task generation prompt and the digital content to a large language model for generating the task list; and
providing, for display on the client device, a visual representation of the task list generated by the large language model.

2. The method of claim 1, further comprising:
providing, for display on the client device, a catalyst bauble that follows client device interactions across computer applications to accompany an active interface window displayed on the client device; and
wherein detecting the entry point trigger comprises detecting a selection of the catalyst bauble to initiate scanning of the active interface window for tasks to include within the task list.

3. The method of claim 1, further comprising generating the task generation prompt by utilizing the catalyst application to:
scan the digital content depicted within the application window to generate a text representation of the digital content; and
generate a natural language request for generating the task list by generating terminology requesting task generation from the text extracted of the digital content.

4. The method of claim 3, further comprising, in response to the task generation prompt, causing the large language model to generate the task list by analyzing the terminology of the natural language request and the text representation of the digital content.

5. The method of claim 1, wherein providing the visual representation of the task list comprises providing, for display on the client device, a catalyst interface depicting at least one task within the task list, an indication of an overall objective associated with the task list, and a target audience associated with the task list.

6. The method of claim 1, further comprising:
providing, for display on the client device, a fidelity adjuster selectable to modify a fidelity of task generation from the digital content; and
in response to user interaction with the fidelity adjuster to set a modified fidelity, modifying the task list to include a different number of tasks according to the modified fidelity.

7. The method of claim 1, further comprising:
receiving a request from the client device to break down a task within the task list into additional tasks; and
in response to the request, generating, for the task, nested tasks that indicate actions at an increased level of granularity as compared to the task within the task list.

8. A system comprising:
at least one processor; and
a non-transitory computer readable medium comprising instructions that, when executed by the at least one processor, cause the system to:
detect an entry point trigger for initializing a task catalyst application on a client device;
in response to the entry point trigger, utilize the task catalyst application to generate, from digital content depicted within an application window presented on the client device, a task generation prompt defining a request to generate a task list from the digital content depicted within the application window;
cause a large language model to generate the task list from the digital content in response to the task generation prompt; and
provide, for display on the client device, a visual representation of the task list generated by the large language model.

9. The system of claim 8, further comprising instructions that, when executed by the at least one processor, cause the system to:
receive, from the client device, a request to execute a task with the task list; and
in response to the request, execute the task by communicating with one or more external models connected to the catalyst application.

10. The system of claim 8, further comprising instructions that, when executed by the at least one processor, cause the system to generate the task list by providing contextual information from a knowledge graph to the large language model to inform task extraction based on relationships among user accounts.

11. The system of claim 8, further comprising instructions that, when executed by the at least one processor, cause the system to:
determine, in response to a request to execute a task with the task list, that additional information is needed to execute the task; and
generate a follow-up question to provide to the client device prompting a response to indicate the additional information.

12. The system of claim 8, further comprising instructions that, when executed by the at least one processor, cause the system to:
identify an additional task by utilizing the catalyst application to analyze additional digital content depicted within a new application window presented on the client device;
determine that the additional task relates to the task list generated from the digital content; and
add the additional task to the task list in response to determining that the additional task relates to the task list.

13. The system of claim 8, further comprising instructions that, when executed by the at least one processor, cause the system to:
identify an additional task by utilizing the catalyst application to analyze additional digital content depicted within a new application window presented on the client device;
determine that the additional task does not relate to a previously generated task list; and
automatically execute the additional task based on determining that the additional task does not relate to a previously generated task list.

14. The system of claim 8, further comprising instructions that, when executed by the at least one processor, cause the system to detect the entry point trigger by detecting one or more of:
a client device interaction with a catalyst bauble provided for display to accompany the application window presented on the client device; or
audio data indicating a task from a virtual meeting that includes the client device.

15. A non-transitory computer readable medium comprising instructions that, when executed by at least one processor, cause the at least one processor to:
detect an entry point trigger for initializing a task catalyst application on a client device;
in response to the entry point trigger, utilize the task catalyst application to generate, from digital content depicted within an application window presented on the client device, a task generation prompt defining a request to generate a task list from the digital content depicted within the application window;
provide the task generation prompt and the digital content to a large language model for generating the task list; and
provide, for display on the client device, a catalyst interface corresponding to the task list generated by the large language model.

16. The non-transitory computer readable medium of claim 15, further comprising instructions that, when executed by the at least one processor, cause the at least one processor to generate the task list by utilizing the catalyst application to:
generate the task generation prompt to include a text representation of the digital content depicted within the application window presented on the client device; and
generate the task generation prompt to include a text representation of audio data captured from a virtual meeting that includes the client device.

17. The non-transitory computer readable medium of claim 15, further comprising instructions that, when executed by the at least one processor, cause the at least one processor to:
receive, from the client device, an indication of positive feedback for the task list generated by the large language model; and
adjust parameters of the large language model based on the indication of positive feedback.

18. The non-transitory computer readable medium of claim 15, further comprising instructions that, when executed by the at least one processor, cause the at least one processor to:
execute a task within the task list by utilizing the catalyst application to communicate with one or more external computer applications; and
provide, for display on the client device, a visual representation of one or more data sources used to execute the task via the one or more external computer applications.

19. The non-transitory computer readable medium of claim 15, further comprising instructions that, when executed by the at least one processor, cause the at least one processor to perform an observation function for presenting, for display on the client device, a visualization of the catalyst application executing one or more tasks within the task list.

20. The non-transitory computer readable medium of claim 15, further comprising instructions that, when executed by the at least one processor, cause the at least one processor to:
receive, from the client device, an indication to interrupt execution of a task from the task list; and
in response to the indication, interrupt execution of the task to change task execution parameters before resuming execution of the task.
